(19) United States
(12) Patent Application Publication
(10) Pub. No.: US 2008/0023453 A1
(43) Pub. Date: Jan. 31, 2008

(54) Methods and apparatus for delivering laser energy for joining parts

(76) Inventor: Ping Ye Zhang, San Diego, CA (US)

Correspondence Address: HIGGS, FLETCHER & MACK LLP, 2600 FIRST NATIONAL BANK BUILDING, 401 WEST "A" STREET, SAN DIEGO, CA, 92101-7910, US

(21) Appl. No.: 11/879,371

(22) Filed: Jul. 16, 2007

Related U.S. Application Data
(60) Provisional application No. 60/831,733, filed on Jul. 17, 2006.

(51) Int. Cl. B23K 26/20; B23Q 3/12

(52) U.S. Cl. 219/121.64; 219/121.63; 269/288

(57) ABSTRACT

A method and apparatus for bonding a pair of tubular members are disclosed. First and second end portions of the tubular members are gripped for rotation about their axis. The tubular members are axially rotated and a laser beam is directed radially toward the tubular members to bond them together.

### FIELD OF THE INVENTION

The present invention relates in general to the field of methods and apparatus to deliver laser energy for joining piece parts composed of materials such as plastic, metal or others. More particularly, the invention relates to joining centric tubular members, such as portions of angioplasty balloon catheters.

### DESCRIPTION OF RELATED ART

This section describes the background of the disclosed embodiment of the present invention. There is no intention, either express or implied, that the background art discussed in this section legally constitutes prior art.

Laser bonding has been successfully utilized in a number of applications to provide welding of piece parts. U.S. Pat. No. 4,990,741 entitled “Method of Laser Welding” is directed towards welding first and second metallic components along a bond path, with the coherent electromagnetic energy laser beam focused by a low turbulent flow of an inert shielding gas along a portion of the path. In U.S. Pat. No. 3,974,016, filed by Bondybey, et al., a method to bond cylindrical strands with plastic jackets using laser energy was disclosed. More specifically, the method discloses a process of bonding wire cables and fiber glass cables with plastic jackets using laser energy. Methods for bonding plastic parts using laser energy were disclosed in U.S. Pat. No. 4,069,080 and U.S. Pat. No. 6,465,757. The methods were used in bonding plastic sheets and films and did not address the issues involved in bonding tubular plastic objects. The patents addressing the bonding of tubular plastic parts using laser energy are U.S. Pat. Nos. 5,267,959 and 5,501,759 both entitled “Laser Bonding of Angioplasty Balloon Catheters.” These patents disclose a method for forming a narrow heat fusion bond between polymeric tubular parts that are specifically used for angioplasty catheters. The bond is created by using monochromatic laser energy at a wave length selected to at least approximately match a wave length of maximum spectral absorption of the polymeric materials. U.S. Pat. No. 6,740,191, issued to Clarke and assigned to Medtronics AVE, Inc., is directed to processes and apparatuses for welding of balloon catheter components. The laser system and spindles of the disclosed laser welding apparatus are left exposed, and as such present a safety hazard to the user.

### BRIEF DESCRIPTION OF THE DRAWINGS

The features of this invention and the manner of attaining them will become apparent, and the invention itself will be best understood by reference to the following description of certain embodiments of the invention taken in conjunction with the accompanying drawings, wherein:

FIG. 1 is an elevational view of a laser welding apparatus having the laser system exposed on the outside of the safety cabinet;

FIG. 2 is an enlarged pictorial view of a laser beam delivery system;

FIG. 3 is an enlarged face view of a collet illustrating it in a tube clamping position;

FIG. 4 is an enlarged face view of the collet of FIG. 4, illustrating it in a fully closed position;

FIG. 5 is a pictorial view of the laser welding components of the apparatus further illustrating a tooling insert gripped by a collet jaws;

FIG. 6 is a sectional view of the components of FIG. 5 gripping a tubular sample without a tooling insert;

FIG. 7 is a block diagram of a combination of various types of laser generators;

FIG. 8 is a break away view of a laser bonding apparatus of the current invention comprising the laser system located within a safety enclosure;

FIG. 9 is a break away view of a laser bonding apparatus of the current invention comprising a safety door for covering the opening of the safety enclosure and having the internal door guide illustrated with dotted lines;

FIG. 10 is a perspective view of one embodiment of a tooling insert of the current invention; and

FIG. 11 illustrates another embodiment of a tooling insert comprising a varied sized lumen.

### DETAILED DESCRIPTION OF CERTAIN EMBODIMENTS OF THE INVENTION

TABLE 1
Parts List

| Part No.: | Part Name |
|---|---|
| 10. | Laser Welding Apparatus |
| 14. | Laser System |
| 15. | Single Laser Generator |
| 16. | Diode Pointer |
| 17. | Laser Beam Delivery System |
| 18. | Moving Plate |
| 19. | Two or More Rails |
| 20. | Safety Enclosure |
| 20A. | Enclosure Protrusion |
| 21. | Hollow Shaft |
| 22. | Programmable Logic Controller |
| 22A. | LCD Display |
| 23. | Left Spindle |
| 24. | Right Spindle |
| 25. | Mechanical Rail |
| 26. | Multi-Segmented Collet for Right |
| | Spindle |
| 27. | Collet Segment |
| 28. | Polygon Housing |
| 29. | Multi-Segmented Collet for Left |
| | Spindle |
| 34. | Balloon Catheter |
| 38. | Catheter Tubing |
| 41. | Tubular Member |
| 42. | Dilation Balloon |
| 47. | Shrink Tubing |
| 48. | Mandrel |
| 80. | Mounting Block |
| 81. | Safety Door |
| 82. | Door Guides |
| 84. | Top Door Bracket |
| 86. | Bottom Door Bracket |
| 87. | Opening in Safety Enclosure |
| 88. | Locking Mechanism |
| 89. | Tooling Insert |
| 90. | Beam Dump |
| 100. | Beam Splitter |
| 110. | Beam Bender |
| 120. | Collimator |
| 130. | Adjustable Spacer |
| 140. | Focus Lens |
| 151. | Multiple Laser Generator Laser |
| | System |
| 151A. | CO. sub. 2 Laser Generator |
| 151B. | YAG Laser Generator |
| 151C. | Diode Laser Generator |
| 151D. | Excimer Laser Generator |
| 162. | Beam Combiner |
| 175. | |
| 186. | Collimator |
| 187. | Focus Lens |

It will be readily understood that the components of the embodiments as generally described and illustrated in the drawings herein, could be arranged and designed in a wide variety of different configurations. Thus, the following more detailed description of the embodiments of the system, components and method, as represented in the drawings, are not intended to limit the scope of the invention, as claimed, but is merely representative of the embodiments of the invention.

An apparatus and method for bonding a pair of tubular members are disclosed. The apparatus comprises an improvement over the prior art by providing features for added safety, for improved welding accuracy and for laser welding process design, analysis and reproducibility.

The embodiments relate to the field of methods and apparatus which are well suited for delivering laser energy to bond and/or shape tubular parts (plastic or metal, for example). First and second end portions of the tubular members are gripped for rotation about their axis. The tubular members are axially rotated and a laser beam is directed radially toward the tubular members to bond them together. The laser beam may also be moved axially relative to the rotating tubular members to achieve a desired bonding characteristic.

According to one aspect there is provided an apparatus with added safety features. According to an embodiment, the apparatus may include a safety enclosure which may be a housing fixture including one or more internal chambers with electrical, mechanical and optical components enclosed inside. The one or more chambers inside of the safety enclosure are accessed through openings in the safety enclosure body. In one embodiment, the laser system is enclosed within the safety enclosure of the laser welding apparatus. It is preferred that the laser system is mounted to the rear wall within the safety enclosure. In this embodiment, laser energy that is emitted from the laser system due to leaks or undetected damage to the laser system will remain contained within the safety enclosure.

In another embodiment, the safety enclosure of the laser welding apparatus comprises a safety door covering the opening. The door may operate manually or automatically along with the start of a laser bonding process cycle. The safety door may operate about a hinge system attaching one side of the safety door to an edge of the safety enclosure at the opening. Alternatively, the safety door may operate using at least one rail and an actuator motor. It is preferred that the laser bonding processing cycle is prevented from beginning when a safety door is open. It is also preferable that the safety door is locked during the laser bonding processing cycle. The door can further comprise a locking mechanism to prevent opening of the door during laser operation.

In another aspect there is provided an apparatus with added features for improved accuracy of laser welding. In one embodiment, there are provided tooling inserts used for precise fit of a sample into the collet jaws of the apparatus. Tooling inserts are particularly useful with samples having small diameter ends, having non-uniformly sized ends or having uneven profiles. Here the tooling inserts will fit the sample ends and are gripped by the collet jaws of the laser bonding apparatus. The outer dimensions of the tooling insert provide a precise fit within the collet jaws.

According to an embodiment, there is provided a process monitoring system for on-line process monitoring. It may include a digital camera, a high resolution monitor, a lens system, and a camera mounting system. The process monitoring system may include a crosshair function that is displayed on the monitor screen allowing for precision targeting of the laser system to an area of the tubular sample to be laser bonded.

In another aspect there is provided an apparatus with added features for designing, analyzing and reproducing laser welding processes using the laser welding apparatus. In one embodiment, the laser welding apparatus interfaces with a computer.

According to one embodiment, there is provided an external computer system that communicates with the laser welding apparatus. The communication may be through wired or through wireless means. In a preferred embodiment, the communication is wired and the laser welding apparatus comprises a Universal Serial Bus (USB) port to accept the wired communication link with the computer. Communication between the laser welding apparatus and the computer system allows for information regarding a laser process to be designed, analyzed and reproduced on one or more laser welding apparatuses.

According to other embodiments, a control system hardware may include hardware support for the laser apparatus to fulfill its functionality. It may include a PLC (program logic controller), DC power supplies, motor driver(s), laser control circuitry, operator interface, including control panels and computers, and appropriate LCD displays. The control system software may be a software program that controls all the activities of the laser bonder. The control system software may be run on an external computer.

In one preferred embodiment, the laser bonder may be programmed to run in a manual mode, a static mode, a dynamic mode and a multi-step mode. In manual mode, the laser beam power density and spindle rotational speed may be pre-specified. The apparatus of the present embodiment may enable users to manually control the laser beam movement and laser beam duration time. The manual mode may be useful for welding/reshaping process exploration. In static mode, the laser beam power density, laser beam duration, and spindle rotation speed may be pre specified. The laser beam may be directed onto the desired location without movement. This type of program may be useful for creating a smallest possible, or at least greatly reduced, welding zone. In dynamic mode, the laser beam power density, laser beam travel distance, laser beam travel speed, and spindle rotation speed may be pre-specified. The laser beam may emit while traveling, which may create extended welding areas or help reshape piece parts such as tip tapering. The multi-step mode may be a combination of static and dynamic modes. With a multi-step program, a simple welding/reshaping process may be developed with accuracy for various welding applications. In a further aspect of this embodiment, these modes are accomplished using an external computer in wired or wireless communication with the laser welding apparatus.

The laser welding apparatus delivers laser beams with wave lengths selectively to the rotating members to be joined.

The apparatus may include at least one laser generator which is the power source to heat tubular piece parts to be bonded and/or shaped. The laser may be of type CO.sub.2, YAG, Excimer, or diode laser, with a wave length in the range of 300 nm to 15 .micro.m. Particularly, multiple laser generators with different wave lengths may be combined to provide wide coverage of various types of polymers, polymer blends, and polymers with specially formulated coating of absorbing agents. Where multiple laser generators are used, a beam combiner for each generator may be used to introduce the beam into the main laser beam. In addition, the wave length for each laser generator may be independently adjustable. For such a multi-generator and multi-wave length system, the final laser beam may contain only one monochromatic beam or combinations of multiple wave lengths.

The apparatus may include at least one beam delivery system which shapes and focuses the laser beam generated by the laser generator and delivers the laser beam to the predetermined location. The laser beam system may include a lower power diode laser pointer to guide the laser beam; a set of beam path enclosure tubes to prevent operators from accessing the laser beam; one or more mirror block or blocks should it be necessary or important to change the direction of the laser beam; a beam expander to enlarge the beam waist, collimator to make the enlarged beam parallel, and an integral focus lens to shape and focus the collimated laser beam at the predetermined location. Such beam delivery system may allow easy adjustment for laser beam spot size and laser beam focus distance for various piece parts bonding/shaping applications. Cylindrical focus lens may be used to create focused laser line instead of spot.

The laser system motion hardware may move the laser system at one or more directions so that bonding/shaping may be formed in certain patterns. The laser system motion hardware may include a moving plate, at least one linear actuator that drives the moving plate, a base plate, at least one rail placed between the moving plate and the base plate. The moving plate may situate the laser generator and laser beam delivery system in place and may move at pre-determined directions, speeds and travel distances. The rails may be aligned so that single-axis or multi-axis movement of the laser system may be created.

The rotational fixtures of the apparatus may hold the samples to be bonded in place and rotate the samples to create circumferential welds. The rotational fixtures may include left and right spindles that rotate at the same speed. Each spindle may include a hollowed shaft that may allow long samples to run through, a sample holder that may hold and rotate the samples without damaging them, and a motor that drives the spindle. The rotational motion of the spindles may be continuous or it may be intermittent. The intermittent motion may be used to create non-continuous patterned circumferential bond.

The embodiments may also provide methods of welding and/or shaping piece parts. In one preferred embodiment, the method may include the steps of: a) placing piece parts to be welded or shaped into tooling inserts which in turn are placed into rotation fixtures; b) positioning the laser pointer to be welded or to be reshaped site using the cross-hair feature; c) adjusting laser beam focus distance, laser beam spot size for different piece part materials and dimensions, to achieve desired welding dimensions and welding strength; d) rotating the piece parts as needed in predetermined rotation speed to achieve annular welding zone; e) selecting and/or creating laser bonding processing cycle programs; and f) starting the laser beam to the desired location to start a welding or reshaping process.

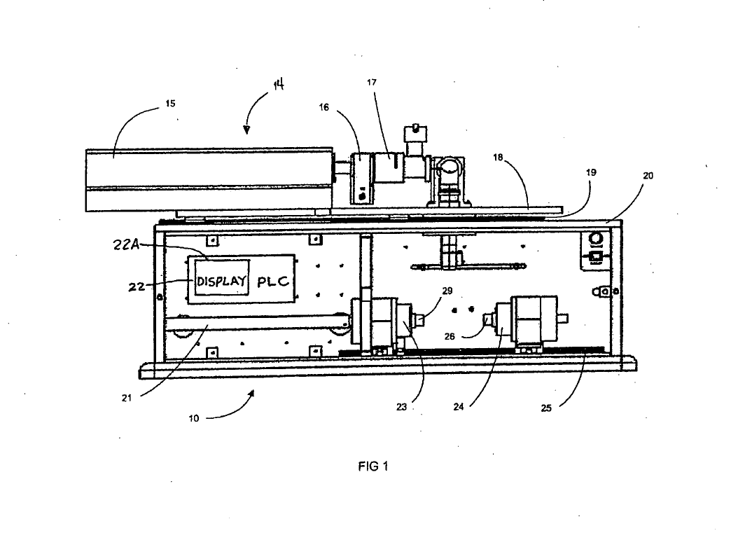

Referring now to the drawings, FIG. 1 is the front view of a laser welding apparatus 10, wherein the laser system 14 is placed on top of the safety enclosure 20. The laser system 14 shown in FIG. 1 comprises a single laser generator 15, a diode pointer 16, and a laser beam delivery system 17 resting on and supported by a moving plate 18 which in turn is mounted for movement on two or more rails 19. The entire laser system including the moving plate and the mechanical rails are mounted on top of a safety enclosure 20. Inside the enclosure, there is a left spindle 23 and a right spindle 24. The left spindle is extended with a hollow shaft 21 for long sample support. Both the left and the right spindles may be mounted for movement along a mechanical rail 25. The right spindle 24, may be moved adjustably left and right along the rail. In this configuration wherein the laser system is outside of the safety enclosure, users and others in the vicinity of the laser welding apparatus are exposed to laser energy emissions from the laser system.

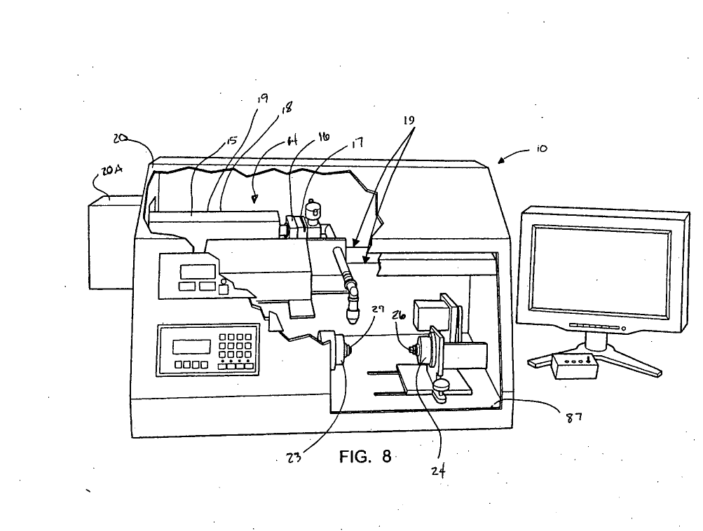

In the drawings of FIG. 8, the laser system 14 is mounted within the safety enclosure 20. In this embodiment, similar to as described above, the laser generator 15, the diode pointer 16, and the laser beam delivery system 17 are attached to the moving plate 18 which is in turn attached to two or more rails 19. The two or more rails 19 are attached within the safety enclosure 20 to the rear panel of the safety enclosure 20. In the illustration, two or more rails 19 are shown attached to rear panel and running in parallel from behind moving plate 18 and laser generator 15. This is just an exemplary configuration of at least two rails 19, and those skilled in the art will readily adapt other configurations. Other areas are equally acceptable for attachment of the laser system so long as the placement of the laser system allows for the interior components to work properly and remain unobstructed by each other during use. Enclosing the entire laser system inside of the safety enclosure provides shielding from emitted laser energy by the safety enclosure. In a preferred embodiment, the material constructing the safety enclosure is stainless steel, anodized alumina, laser-proof plastic or other material that is suitable to contain laser energy.

To keep the footprint of the laser welding apparatus 10 as small as possible, safety enclosure 20 includes protrusion 20A, which houses a portion of the laser generator 15. FIG. 8. Protrusion 20A is positioned with respect to the remainder of safety enclosure 20 based on placement of laser system 14 within the safety enclosure 20. Safety enclosure 20 can alternatively have a larger footprint, which will eliminate protrusion 20A. In FIG. 8, protrusion 20A houses a portion of laser generator 15.

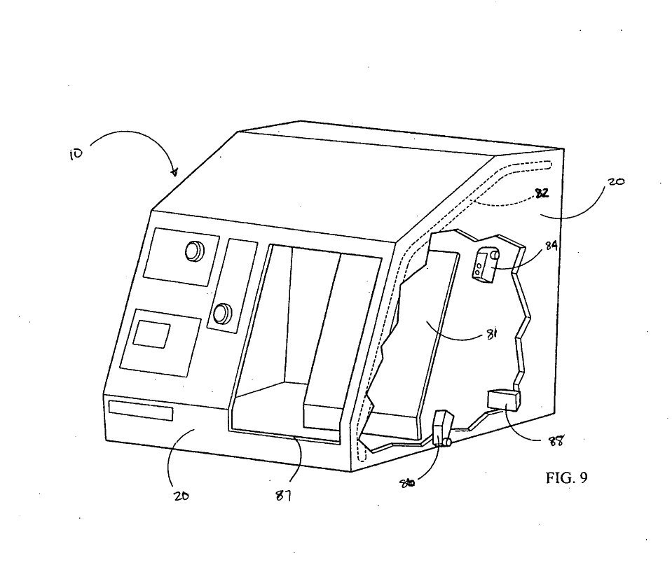

Safety enclosure 20 is a fixture with one or more internal chambers, which house the electrical, mechanical, and optical components, such as the rotation fixtures and the laser system. Access to these chambers is through openings in the safety enclosure 20. FIG. 8 shows a preferred embodiment of the safety enclosure 20 wherein there is a single opening 87 allowing access into the interior chamber and to the left and right spindles, 23 and 24, respectively, for sample placement. In this embodiment of the laser welding apparatus the single opening comprises a safety door 81; illustrated in FIG. 9. The safety door 81 can be manually or automatically operated. FIG. 9 shows the safety door 81 comprises a door guide 82, a top door bracket 84, a bottom door bracket 86 and a lock mechanism 88. There is preferably a door guide on the left side of the opening 87 (not shown) and a door guide 82 on the right side of the opening 87. The left side door guide can be a strip of material (preferably stainless steel) that comprises a channel for the left side top and bottom door brackets to insert and travel within. The left side door guide can be attached within safety chamber 20, for example, to the top panel. Shown attached to safety door 81 at the right side are a top door bracket 84 and a bottom door bracket 86, and these brackets are inserted into the right door guide 82. Safety door 81 opens and closes across the opening 87 by the movement of the brackets 84 and 86 through the right door guide 82, the left door guide or both door guides. Automatic movement may be facilitated by an actuator or other motor (not shown). A locking mechanism 88 is included to prevent accidental opening of the safety door during a process cycle. In this embodiment, the locking mechanism 88 is a magnet. The safety door 81 can be made of a suitable material comprising stainless steel, anodized alumina or laser-proof plastic. The safety door 81 can be transparent, for example when made from a laser-proof plastic, thereby allowing for observation of the bonding process. In a preferred embodiment, safety door 81 is automatically closed when the laser welding apparatus 10 is started. Safety door 81 remains closed and locked throughout the process cycle, and completion of the process cycle will allow the safety door 81 to automatically open.

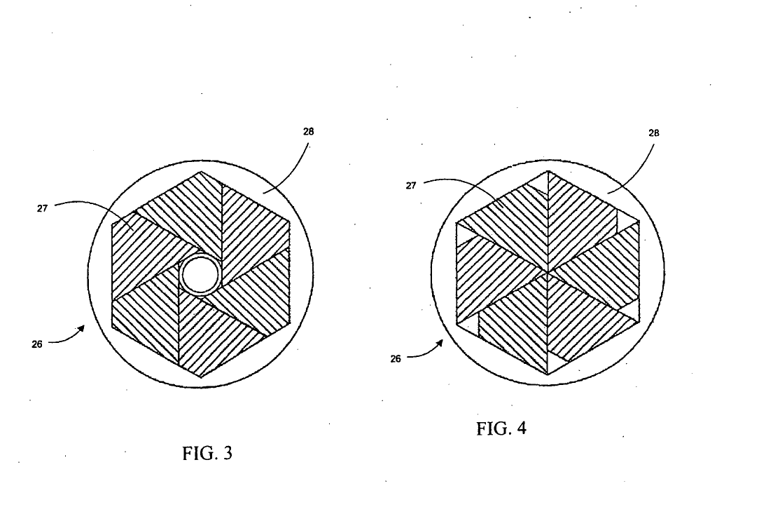

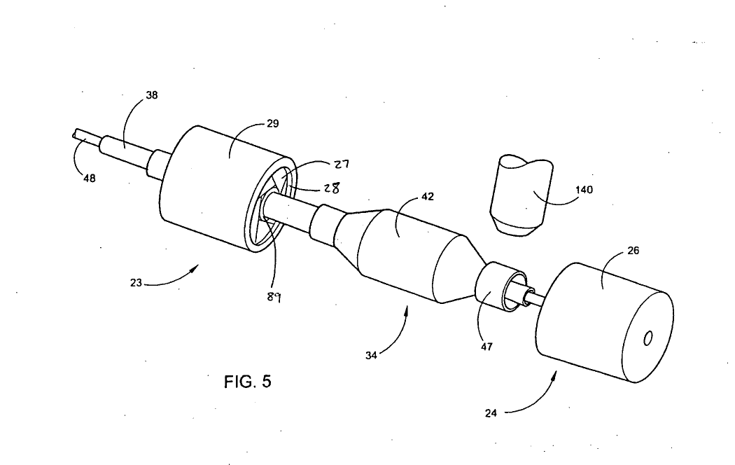

FIG. 3 and FIG. 4 illustrate a multi-segmented collet 26 forming a part of the spindle 24, the spindle 23 having a similar collet 29 (FIG. 1). Each collet has three or more identical segments such as a segment 27. The segments are fit into a polygon housing 28 that allows the segments to move along each side of housing. As a result, the opening formed by the inner sides of the segments may be adjusted continuously. This is superior to the collet system used in machine tools in that the collet system in the current invention does not have any gap between segments. This eliminates the possibility of pinching the tubing that may be trapped in the gap (FIG. 3). It also may have the advantage of providing a larger adjusting range for the opening.

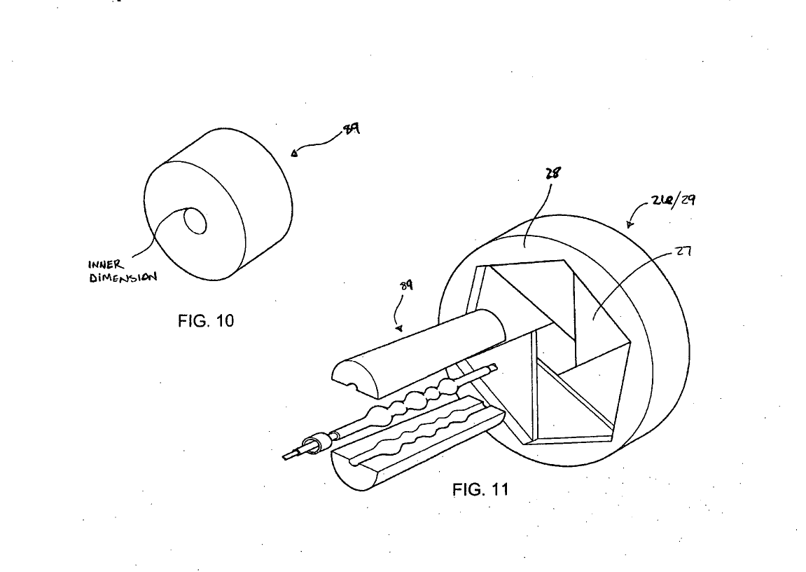

FIG. 10 and FIG. 11 illustrate tooling inserts 89 that are used with the collet system. With tubular samples that have very small diameters the collets 26 and 29 may not grip the sample tightly and thus the small tubular sample may remain loose after the segments are clamped down. By way of example only, a 0.010-inch diameter tubular sample may not be tightly gripped in the collet segments because of the small size. Additionally, tubular sample that have non-uniform sized ends require that each collet is independently programmed to grip a separate diameter. With tubular samples that have an uneven profile a collet may not be able to achieve a thorough grip on the sample end because of changes in the dimensions. A tooling insert 89 is therefore provided. Tooling insert 89 is shaped to be tightly gripped by the collet segments and further comprises a center portion that precisely fits the tubular sample, including, but not limited to, small diameter tubular inserts, non-uniform end sizes tubular inserts and uneven profile end tubular samples.

Tooling insert 89 comprises an outer diameter, an inner diameter and a width dimension. FIG. 10. The outer diameter is large enough to be tightly gripped by the collet segments and the inner diameter is set to accommodate the tubular sample. Preferably, the outer diameter is from 0.6-inches to 0.1-inch, more preferably from 0.45-inches to 0.2-inches and most preferably about 0.3-inches. Preferably, the inner diameter ranges from about 1-French (Fg. or Ch., herein, “French”) to about 30-French in size, more preferably from about 2-French to about 20-French and most preferably about 12-French. Those ordinarily skilled in the art will readily recognize that these explicitly recited ranges are exemplary for describing the tooling inserts and spirit of the invention includes the unstated sizes as well. The width of the tooling inserts 89 are at least sufficient to operate with the collet segments. The tooling inserts 89 will assure a proper and easy fit of a tubular sample into the collet segments.

Each end of a tubular sample is first inserted into the inner diameter of a tooling insert 89 having a measurement matching that end of the tubular sample. The tubular sample and tooling insert 89 are then tightly gripped by the collet segments. Using the tooling insert 89 allows for the collet segments to be opened to a precise size based upon the outer diameter of the tooling inserts 89, and not based upon variously sized tubular samples. Alternatively, the tooling insert 89 can be first gripped by the collet segments and then the tubular member can be inserted into inner diameters thereof. By way of example, a tubular sample having non-uniform first and second ends measuring 5-French and 12-French, respectively, can be fitted with a first tooling insert 89 with an inner dimension measuring 5-French and a second tooling insert 89 with an inner measurement measuring 12-French. The tooling inserts 89 are tightly gripped by the collet segments 26 and 29 without regard for the dimensions of the ends of the tubular sample and without independent adjustment.

In an alternative embodiment the tooling insert 89 comprises an outer diameter that is large enough to be tightly gripped by the collet jaws and an interior lumen that is configured to accommodate the size and shape of a tubular sample. In this embodiment, the tooling insert 89 opens to form two half pieces and thus expose the interior lumen. The tubular sample is placed within the lumen and the two halves of the tooling insert 89 are reassembled to close around the tubular sample. The tooling insert is then gripped by the collet jaws as described above. Tooling inserts 89 comprising a lumen to accommodate the size and shape of a tubular sample are particularly useful with tubular samples having an uneven profile. FIG. 11.

In one embodiment, a control system hardware includes a programmable logic controller (PLC) 22 with at least two channels of stepper motion control outputs. FIG. 1, a LCD display 22A that serves as a direct machine interface allows the user to program the laser bonder and to acquire operating information. In a preferred embodiment, the control system hardware includes a remote computer and a wired or wireless communication means that serves to communicate information regarding the laser process to the remote computer. In a preferred embodiment, the remote computer and laser welding apparatus 10 communicate using a wired communication means, such as a USB port and compatible cable. Alternatively, the computer and laser welding apparatus communicate using a wireless communication means. Transfer of data between the laser welding apparatus 10 and the computer allow for programming and analysis of the laser processing of a tubular sample. Data can also be transferred between the remote computer and a plurality of laser welding apparatus. Accuracy of the laser processing on a tubular sample as well as sample to sample consistency are achievable using the programming, transfer and/or reuse of information.

A control system software comprises a set of ladder logic program codes, which may provide the following four types of programs: a) manual bonding in which the percent of laser power and sample rotational speed are preset, while the bonding duration and laser movement is controlled manually by the operator; b) static bonding with which the laser system does not move during bonding. In this type of programs, the percentage of laser power, the rotational speed, and the bonding duration must be preset; c) dynamic bonding with which the laser system is moving while the laser is firing, in the type of programs, the percentage of laser power, the rotational speed, the laser travel speed and travel distance must be preset; and d) multi-step bonding which is a combination of static and dynamic bonding programs. Preset instruction and manual control are preferably delivered and received using the remote computer and the communication means.

A process monitor system is provided and comprises a digital camera, a lens and a mounting system, within the safety enclosure 20, and a monitor outside of the safety enclosure 20. The digital camera is directed towards the site of a tubular sample when gripped between the collets 26 and 29. Images of the supported tubular sample are acquired by the camera and lens and are communicated to an external monitor. Preferably, the digital camera position is directed to the tubular sample processing stage area. In an alternative embodiment the digital camera position is adjustable and the position of the digital camera is controlled from outside of the laser welding apparatus 10. The digital camera mounting system, therefore, can be adjustable. The adjustable mounting system further comprises a position adjustment means comprising a rail and actuator system, a ball and joint system or a combination thereof. In a more preferred embodiment, the external monitor comprises a cross-hair function corresponding to the targeting of the laser system and allowing for accurate alignment of the laser to the tubular sample before laser processing.

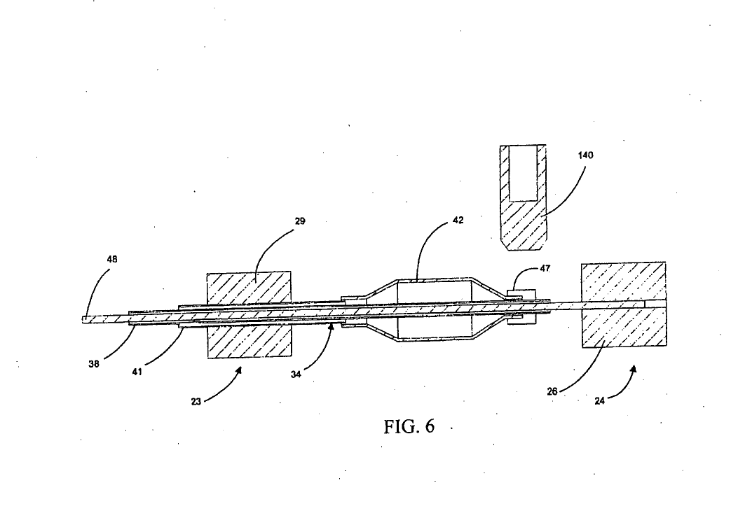

Referring now to FIGS. 5 and 6 on the drawings, a balloon catheter 34 is supported between the collets 26 and 29. The catheter includes a catheter tubing 38 and a dilation balloon 42 concentrically surrounding the catheter tubing 38 with a tubular member 41 interposed between the proximate end of the balloon 42 and the catheter tubing 38. A shrink tube 47 loosely surrounds the distal end or tip of the balloon 42 and the catheter tubing 38.

A mandrel 48 extends through the interior of the catheter tubing 38, and its right hand end is gripped in the collet 26. The collet 29 grips the combination of the tubular member 41, the catheter tubing 38 and the mandrel 48. The collets 26 and 29 are driven into rotation at the same speed in synchronism to cause the catheter 34 to rotate about its axis as the laser beam is emitted from the focus lens 140 onto the shrink tube 47. Thus, the catheter is securely held in place as it rotates axially to help provide a precise weld between the distal end of the balloon 42 and the distal end of the inner catheter tubing 38.

In accordance with an embodiment of the invention, the balloon catheter illustrated in FIG. 5 is inserted into a tooling insert and the tooling insert is gripped between the segments of collets 26 and 29.

In accordance with an embodiment of the invention, the laser system including the focus lens 140 is adapted to move in a direction generally parallel to the axis of the catheter 34 as it rotates to provide for different desired welding or shaping operations.

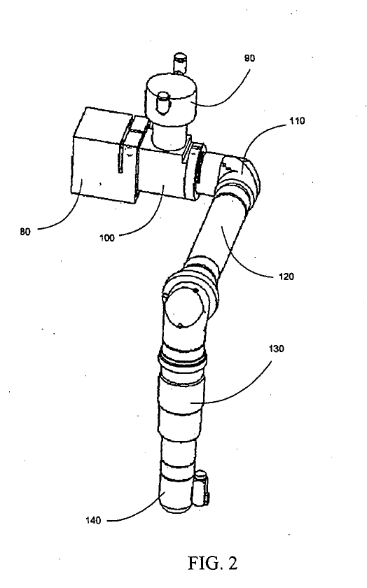

FIG. 2 is a 3D view of a laser beam delivery system utilized in the present invention. It consists of a mounting block 80, a beam dump 90, a beam splitter 100, one or more beam benders 110, a collimator 120, an adjustable spacer 130, and pre-mounted focus lens 140. In this particular arrangement, the beam splitter 100 splits the main laser beam into two portions. One portion travels forward along the main beam path and towards the bonding site. The other portion is branched off the main laser beam and is directed to the beam dump 90. The percentage of the dumped portion is between about 50% and about 90%. The beam benders 110 are used to change the direction of the laser beam. The collimator 120 expands the laser beam which effectively changes the focused spot size. The adjustable spacer 130 is used to adjust the location of the focus point. In this particular arrangement, the spacer can be adjusted in a 1.25″ range. The focus lens 140 is used to focus the laser beam on the welding site. The focus lens can be round shape or cylindrical. The round lens will generate a laser spot at the welding site, while cylindrical lens will generator a laser line at the welding site.

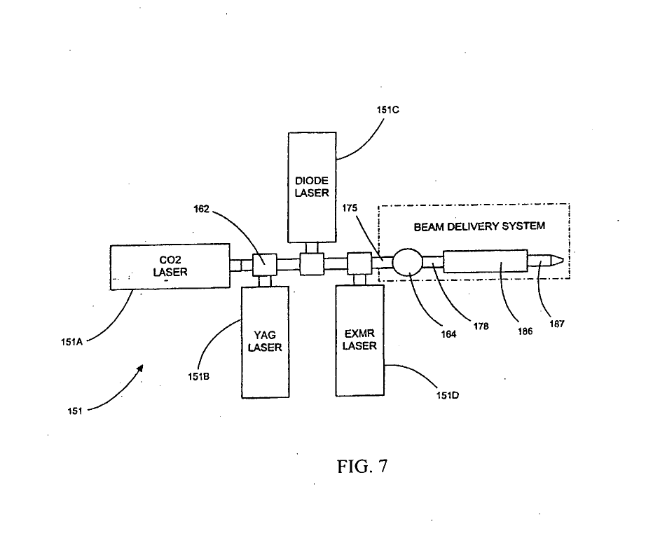

Referring now to FIG. 7, there is shown a laser system 151 with multiple laser generators. The system 151 is constructed according to an embodiment of the present invention, and is similar to system of FIG. 1, except that the system 151 includes a plurality of laser generators. In this particular arrangement, a CO.sub.2 laser generator 151A, a YAG laser generator 151B, a diode laser generator 151C, and a excimer laser generator 151D are combined to form a laser energy source that provide a laser beam with multiple wave lengths. The CO.sub.2 laser generator 151A, is aligned with the main laser beam. A beam combiner generally indicated at 162 is attached to each other type of laser generator to introduce the corresponding laser beam into the main laser beam. The beam combiners are linked with beam path enclosure tubes indicated generally at 175. At the end of the multi-wave length laser generator, there may be a diode pointer (not shown) which may be included for providing a low power visible guiding beam for sample alignment. A component 164 is a beam dump which is used to branch a certain percentage of laser power from the main laser beam to reduce the effective power. The remaining portion of the laser beam is then beam expanded and collimated through a collimator 186. It is then focused through a focus lens 187.

A method for bonding a pair of tubular members of a catheter is provided. In this non-limiting example a tubular sample comprising two small ends is bonded. Each of the ends is inserted into a first and second tooling insert. The tooling inserts are selected from a plurality of tooling inserts. The plurality of tooling inserts are available having inner diameters ranging from about 5-French to about 12-French. In this example, the ends of the tubular sample are uniform in size, and both needing a tooling insert with an inner diameter of 6.873-French. However, the ends of the tubular sample may be non-uniform, in which case the inner diameter of a selected tooling insert will correspond with the end of the sample to which it is directed. The ends of the tubular sample are placed within the tooling inserts and the tooling inserts are gripped by first and second collet jaws of a first and second multi-segmented collet system. Using a remote computer communicating with the laser welding apparatus via wired communications, a digital camera within the laser welding apparatus is targeted to the welding site. This targeting is controlled at the computer and is viewed on a monitor. To assist with targeting precision, the monitor is equipped with a cross hair feature. The laser is in turn directed to the target site and a laser bonding process cycle begins. Each tubular member of the tubular sample is rotated about their axes in synchronism and the laser beam is directed radially toward the tubular members to bond them together. The laser beam movies also moved axially.

In a further example, the end of a tubular sample is uneven and the tooling insert is custom designed to fit the contours of the uneven tubular sample end having contours ranging from about 1-French to about 20-French. Thus, a tooling insert with a single inner diameter dimension will be difficult to precisely fit on the sample end. The tooling insert for this configuration is separable into two portions, thereby exposing the lumen of the tooling insert. The lumen is shaped with a contour that fits the sample end and is exposed when the tooling sample is separated into portions. The sample end is laid into the exposed lumen of a first portion, and the remaining portions are closed around the end. The tooling insert is then placed in the collet jaws. Laser processing is achieved using a combination of some or all of the steps disclosed above.

While particular embodiments of the present invention have been disclosed, it is to be understood that various different modifications are possible and are contemplated within the true spirit and scope of the appended claims. For example, the apparatus and method of the present invention may be implemented in a variety of different ways including techniques not employing threads.

What is claimed is:

1. A method of bonding a pair of tubular members of a catheter, comprising:
inserting at least one end portion of the tubular members into a tooling insert;
gripping the tooling insert within a first collet jaws for rotation about their axes;
optionally inserting opposite end portions of the tubular members into a tooling insert;
gripping the tooling insert within a second collet jaws for rotation about their axes in synchronism with the rotation of the first-mentioned end portion;
enclosing fully the gripped tubular members and tooling inserts within the safety enclosure of a laser welding apparatus is a position that is accessible to the internal laser welding system so that the laser welding process can be performed on the tubular members to bond them together;
rotating the tubular members axially; and
directing a laser beam radially toward the tubular members to bond them together.

2. A method according to claim 1, further including causing the laser beam to move axially.

3. The method according to claim 1 wherein only one end of the tubular members is inserted into a tooling insert and the opposite end is directly gripped within a collet jaws.

4. An apparatus for delivering laser energy and welding and/or reshaping tubular piece parts using such energy, comprising: a laser system placed within a safety enclosure; a rotation fixture and a sample holder also housed within the safety enclosure and further comprising a multi-segmented collet; the safety enclosure further comprising a safety door; a communication means; and a process monitoring system.

5. The apparatus of claim 4 wherein the laser system further comprises a laser source involving one or more laser generators with different wave lengths; a laser beam delivery system; and a laser system motion hardware.

6. The apparatus of claim 4 wherein the rotation fixture and sample holder further comprises a plurality of removable tooling inserts.

7. The apparatus of claim 6 wherein the removable tooling inserts have an inner dimension to fit a tubular sample and an outer dimension to fit within the multi-segmented collet.

8. The apparatus of claim 7 wherein the removable tooling insert comprises an inner dimension is from about 1-French to about 20-French.

9. The apparatus of claim 7 wherein the inner dimension is a lumen with a varied dimension from about 1-French to about 30-French.

10. The apparatus of claim 4 wherein the safety door further comprises a top bracket, a bottom bracket and a lock mechanism.

11. The apparatus of claim 10 wherein the lock mechanism automatically engages when the laser processing cycle begins.

12. The apparatus of claim 4 wherein the process monitoring system further comprises a digital camera, a camera mounting system, a lens system and a monitor that includes a cross-hair function.

13. The apparatus of claim 4 wherein the communication means is a USB port to accept compatible cable and communicate with a remote computer.

14. A tooling insert for use with a multi-segmented collet system comprising: an outer diameter that fits tightly within the multi-segmented collet system and an inner diameter that fits an end of a tubular sample.

15. The tooling insert of claim 14 wherein the outer diameter is from about 0.6-inches to about 0.1-inch.

16. The tooling insert of claim 14 wherein the outer diameter is from about 0.45-inches to about 0.2 inches.

17. The tooling insert of claim 14 wherein the outer diameter is about 0.3-inches.

18. The tooling insert of claim 14 wherein the inner diameter is a single size from about 1-French to about 30-French.

19. The tooling insert of claim 14 wherein the inner diameter is a single size from about 2-French to about 20-French.

20. The tooling insert of claim 14 wherein the inner diameter is a single size from about 12-French.

21. The tooling insert of claim 14 wherein the inner diameter is a varied size that fits an uneven end of a tubular sample.

22. The tooling insert of claim 21 wherein the outer diameter is from about 0.6-inches to about 0.1-inch.

23. The tooling insert of claim 21 wherein the outer diameter is from about 0.45-inches to about 0.2 inches.

24. The tooling insert of claim 21 wherein the outer diameter is about 0.3-inches.

25. The tooling insert of claim 21 wherein the inner diameter is a variety of sizes from about 1-French to about 30-French wherein the sizes are matching to the profile of a non-uniformly ended tubular sample.

26. A method for targeting a laser to a portion of a tubular sample to be laser welded using the laser welding apparatus of claim 4 comprising the steps of:
inserting a tubular sample into the laser welding apparatus in position for axial rotation;
controlling a digital camera to focus on the tubular sample, wherein the digital camera is mounted within the laser welding apparatus and is controlled using a remote computer communicating with the laser welding apparatus;
directing the digital camera to focus on the section of the tubular sample to receive laser welding wherein the section of the tubular sample to receive laser welding is targeted with a cross hair feature displayed on a monitor; and
performing the laser bonding process cycle wherein the laser beam is directed to the location of the tubular sample targeted in the cross hairs.

27. The method of claim 26 wherein the laser bonding process cycle runs in a manual mode, in a static mode, in a dynamic mode or in a multi-step mode, wherein a remote computer is used to deliver the mode selection instruction.
